(19) United States
(12) Patent Application Publication
(10) Pub. No.: US 2013/0103986 A1
(43) Pub. Date: Apr. 25, 2013

(54) SYSTEMS AND METHODS FOR FUNCTIONAL TESTING USING LEVERAGED DYNAMIC LINKED LIBRARIES

(71) Applicants: Xiaojing Yan, Shanghai (CN); Ellery Lewis Horton, Roanoke, VA (US)

(72) Inventors: Xiaojing Yan, Shanghai (CN); Ellery Lewis Horton, Roanoke, VA (US)

(73) Assignee: GENERAL ELECTRIC COMPANY, Schenectady, NY (US)

(21) Appl. No.: 13/404,368

(22) Filed: Feb. 24, 2012

(30) Foreign Application Priority Data
Oct. 19, 2011 (CN) 201110335088.9

(51) Int. Cl. G06F 11/28

(52) U.S. Cl. 714/32; 714/E11.178

(57) ABSTRACT

A method for functional testing of a power device with an associated software control system includes referencing a dynamic linked library (DLL) file belonging to a software package via a method of a class; instantiating an object of the class in functional testing software; and including a call to the method of the object in the functional testing software, wherein the call to the method executes a function of the referenced DLL, such that the referenced DLL comprises an implementation of the class.

### CROSS-REFERENCE TO RELATED APPLICATION

This application is based on and claims the benefit of Chinese Application No. 201110335088.9, filed on Oct. 19, 2011, the contents of which are incorporated by reference.

### BACKGROUND OF THE INVENTION

The subject matter disclosed herein relates to functional testing of power devices with associated software control systems, and more specifically to leveraging of dynamic linked library files (DLLs) for use in functional testing of a power device with an associated software control system.

Functional testing is a type of quality assurance (QA) testing in which test cases are developed based on the design documents or specifications of a component under test, which may be a power device with an associated software control system. Functional testing may involve the following steps. One or more functions that the component under test is expected to perform are identified, and input data based on the component's specifications and/or design documents is created to make a test case for the one or more functions. The expected output from the component under test for the input data comprising the test case is then determined based on the specifications and/or design documents. The test case is then executed by feeding the input data to the component under test, and the actual output of the component for the test case is recorded. Lastly, the actual output from the component under test and the expected output are compared. Corrections may then be made to the component under test based on the comparison.

Non-automated functional testing may be an error-prone and time-consuming process. In addition to the time required to generate test cases, input data, and expected outputs, the execution of a multiple of test cases by the component under test, so as to cover a large number of possible inputs, may be a complex process. A functional testing engineer must pay close attention during execution of the test cases, and may be required to repeatedly manually toggle various values and parameters, in addition to manually recording raw data that is output by the component under test. In the case in which the component under test includes a power device with associated software control system, the test engineer may also need to monitor the state of individual hardware components comprising the power device during the functional testing.

### BRIEF DESCRIPTION OF THE INVENTION

According to one aspect of the invention, a method for functional testing of a power device with an associated software control system includes referencing a dynamic linked library (DLL) file belonging to a software package via a method of a class; instantiating an object of the class in functional testing software; and including a call to the method of the object in the functional testing software, wherein the call to the method executes a function of the referenced DLL, such that the referenced DLL comprises an implementation of the class.

According to another aspect of the invention, a computer program product comprising a computer readable storage medium containing computer code that, when executed by a computer, implements a method for functional testing of a power device with an associated software control system, wherein the method includes referencing a dynamic linked library (DLL) file belonging to a software package as a method of a class; instantiating an object of the class in functional testing software; and including a call to the method of the object in the functional testing software, wherein the call to the method executes a function of the referenced DLL, such that the referenced DLL comprises an implementation of the class.

According to yet another aspect of the invention, a system for functional testing of a power device with an associated software control system includes a software package, the software package comprising a plurality of dynamic linked library (DLL) files; and functional testing software, the functional testing software comprising an object comprising an instantiation of a class, the class comprising a method that references a DLL of the plurality of DLLs of the software package, wherein the functional testing software further comprising a call to the method of the object that references the DLL, wherein the call to the method executes a function of the referenced DLL during functional testing of the power device and associated software control system, such that the referenced DLL comprises an implementation of the class.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a flowchart of an embodiment of a method for functional testing using leveraged dynamic link libraries (DLLs).

FIG. 2 is an embodiment of a system for functional testing of a power device and associated software control system using leveraged DLLs.

FIG. 3 is an embodiment of an interface for leveraging DLLs into functional testing software.

FIG. 4 is an embodiment of a computer that may be used in conjunction with functional testing using leveraged DLLs.

The detailed description explains embodiments of the invention, together with advantages and features, by way of example with reference to the drawings.

### DETAILED DESCRIPTION OF THE INVENTION

Systems and method for functional testing using leveraged dynamic link library files (DLLs) are provided, with exemplary embodiments being discussed below in detail. A DLL is a type of file that denotes a software resource that is part of a larger software package. Although the larger software package may have a good user interface (UI) for standard applications, the UI may not be flexible for other uses, such as functional testing. However, the functions contained in the DLLs may be needed for functional testing. Therefore, functional testing software may be developed with a specifically designed functional testing UI that executes the DLLs in the software package as needed. This allows the functional testing software to make use of software resources that are part of the software package. Calls to DLLs belonging to a preexisting software package allow communication with the controller of the computer on which functional testing software is executed to be made at the application level instead of at the physical level, which reduces the difficulty of developing functional testing software. The functional testing software may automate the functional testing process, freeing a test engineer from repetitious and time-consuming work, and avoid man-made errors in functional testing. More thorough functional testing of a component may also be achieved through automation. The component tested by the functional testing software that leverages the DLLs may be a power device with an associated control system that is implemented in software, and an example of a preexisting software package from which the DLLs may be leveraged is ToolboxST, which is a proprietary control system software belonging to General Electric (GE). In such an example, the associated functional testing software with the leveraged DLLs may be specifically designed for functional testing of a power device and associated software control system. The power device may be a solar or wind power converter with an associated control system. The software control system may be a MarkVIe control system in some embodiments.

Functional testing software may be developed in any appropriate programming language, including object oriented programming languages such as visual basic (VB) or C++. If the automated functional testing software is written in an object oriented programming language, a call to a DLL from a preexisting software package may be made by developing a class that includes a reference to the memory location of the particular DLL. The reference to the DLL makes the class an external claimed class of DLL. The class may then be instantiated in the functional testing software, and a call to the function of the instantiated class that references the DLL allows the functional testing software to directly execute the DLL in the software package. The DLLs are thereby leveraged for use in the functional testing software.

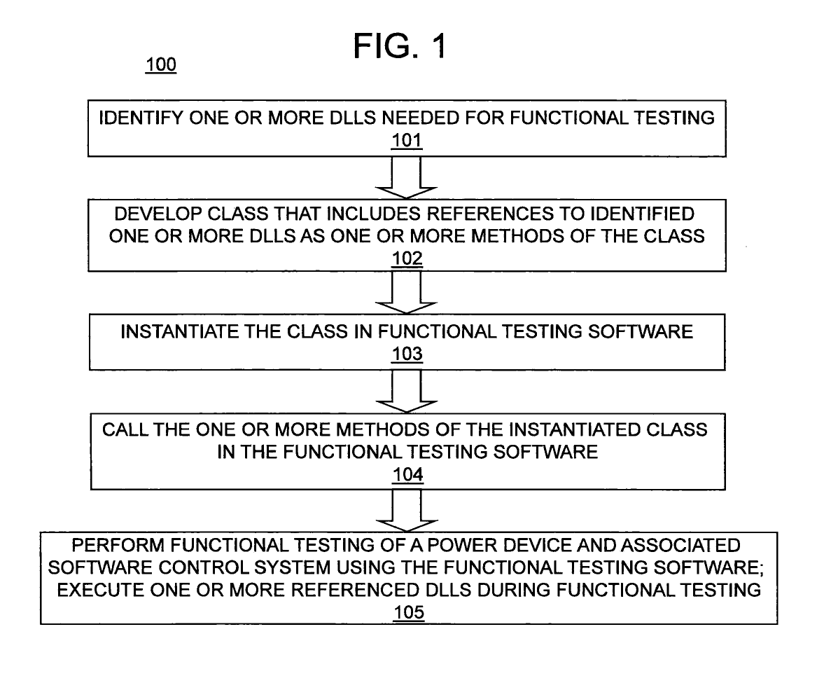

FIG. 1 is a flowchart of an embodiment of a method for functional testing using leveraged dynamic link libraries (DLLs). In block 101, one or more DLLs having functions that are needed for functional testing are identified. The DLLs may be part of a preexisting software package that is not specifically designed for functional testing; an example of such a software package is ToolboxST. The DLLs may be located in a computer memory under the installation location of the software package. Any appropriate number of DLLs in the software package may be identified in block 101. In block 102, a class that includes references to the memory locations of the one or more identified DLLs is developed. The references to the DLLs are the implementation as a method of the class. In block 103, an object of the class developed in block 102, including methods comprising the references to the DLLs, is instantiated in functional testing software. In block 104, calls to the method that references the DLLs of the instantiated object of the class are included in the functional testing software. The calls to the method of the class act as calls to the referenced DLLs using the memory locations. The referenced DLLs comprise the implementation of the class. Then, in block 105, the functional testing software is used to perform functional testing of a power device with an associated software control system. During functional testing of the power device with an associated software control system by the functional testing software, the functions of the referenced DLLs are executed by the calls to the method of the instantiated object of the class that are included in the functional testing software.

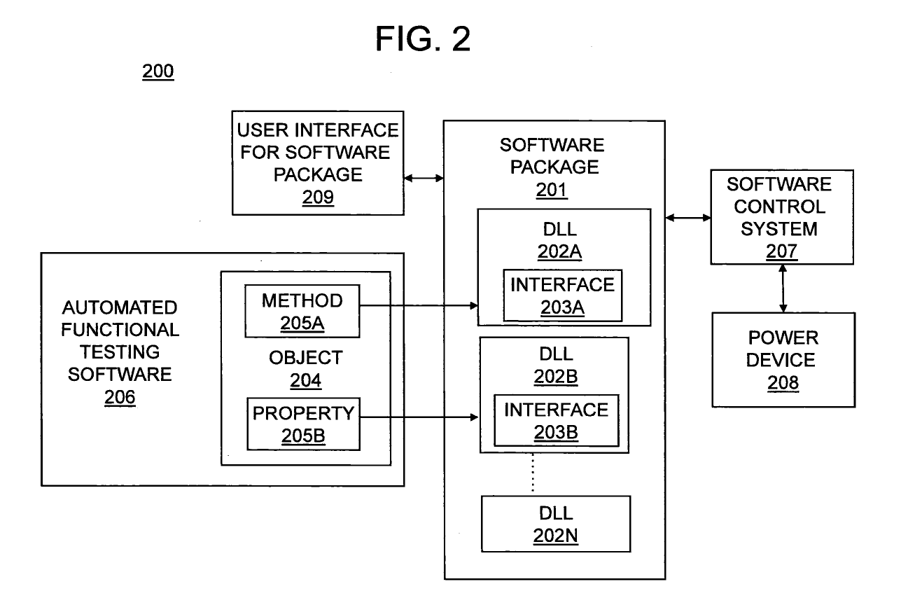

FIG. 2 shows an embodiment of a system for functional testing of a power device and associated software control system using leveraged DLLs. Software package 201 includes a plurality of DLLs 202A-N. Each DLL 202A-N has one or more respective interfaces, such as interfaces 203A-B, that may be referenced by object 204. Software package 201 has a user interface 209 that may be used by a test engineer to perform functional testing of power device 208 and software control system 207; however, user interface 209 may not be adaptable to automated functional testing. Software package 201 may be ToolboxST in some embodiments. Automated functional testing software 206 may therefore use the functionality contained in any of DLLs 202A-N to perform automated functional testing of power device 208 and software control system 207. Object 204 in automated functional testing software 206 is an instantiation of a class that contains method 205 and property 205B. Referencing an interface 203A-B of a DLL allows the object 204 to use make a call to any the functionality of the DLL via methods 205A, such that the DLLs 202A-B comprise the implementation of the class. Object 204 may call any function contained in DLLs 202A-B via interfaces 203A-B. The DLLs 202A-N may perform various tasks including but not limited to causing the software control system 207 to go online, download data, read values, write values, or force variables. The object 204 of the class that contains method 205A and property 205B is instantiated in the automated functional testing software 206, allowing the automated functional testing software 206 to execute the functionality of DLLs 202A-B by calling the method 205A of the object 204. The object 204 may reference properties of DLLs 202A-B via interfaces 203A-B. The automated functional testing software 206 may be used to perform functional testing of power device 208 via software control system 207. The software control system 207 may perform tasks including but not limited to changing parameters in power device 208, reading live input/output values, or reading diagnostics from power device 208. The power device 208 may be, in various embodiments, a solar or wind power converter with an associated control system 207. The software control system 207 may be a MarkVIe control system in some embodiments. FIG. 2 is shown for illustrative purposes only; various embodiments of functional testing software may include any appropriate number of objects, and the classes that are instantiated by the objects may each contain any appropriate number of methods or properties, which may include any appropriate type of subroutines, and that may reference any number of DLLs. Software package 201 may also include any appropriate number of DLLs, and the DLLs may include a plurality of different functions that may be called by the functional testing software via the instantiated object.

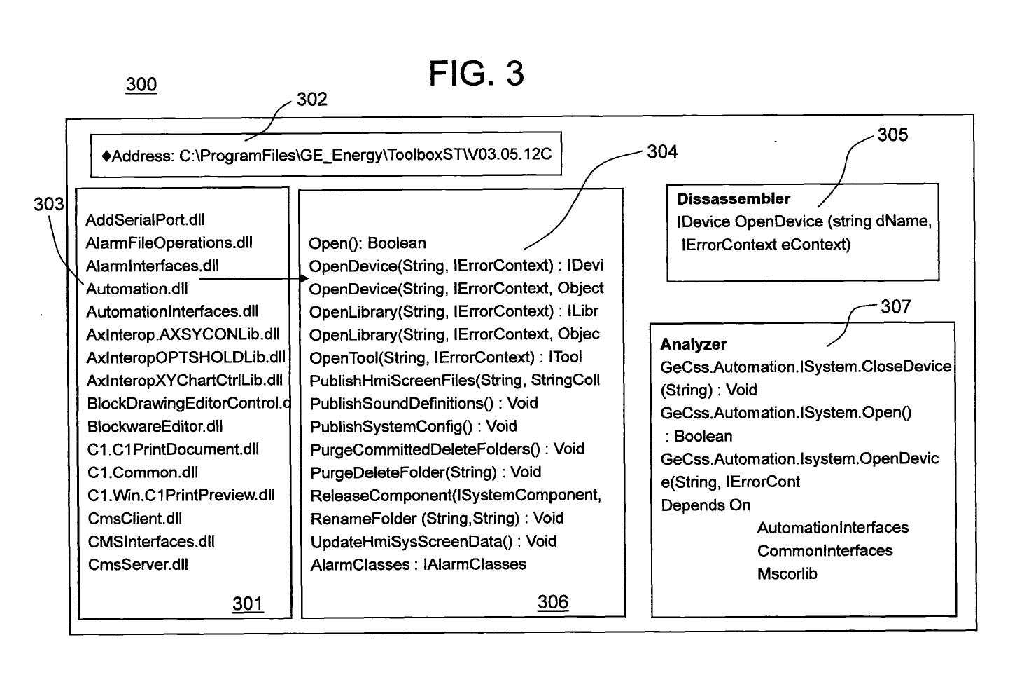

FIG. 3 shows an example of DLLs from ToolboxST being leveraged into a class for use in functional testing software in a visual studio developer interface. A plurality of DLLs belonging to ToolboxST are listed in window 301; the DLLs are located at a memory location indicated by file path 302 (“C:\ProgramFiles\GE_Energy\ToolboxST\VO3.05.12C”). In the example shown in FIG. 3, a one of the DLLs, “Automation.dll” (303), is leveraged for use in functional testing software. “OpenDevice” (304) contains a reference to the memory location of “Automation.dll” (303). “OpenDevice” (304) is a method of the interface “ISystem” (307). The reference to the memory location of “Automation.dll” (303) in method “OpenDevice” (304) allows “Automation.dll” (303) to be called as method “OpenDevice” (304) of the interface “ISystem” (307). Window 306 lists a plurality of methods of the interface “ISystem” (307); any other methods in window 306 may also reference one or more DLLs from window 301. An object “IDevice” (305) of the interface “ISystem” (307) is instantiated in functional testing software by the declaration of object “IDevice” (305); a call to the method “OpenDevice” (304) of the object “IDevice” (305) in the functional testing software acts as a call to “Automation.dll” (303) via the memory location of “Automation.dll” (303) that is contained in method “OpenDevice” (304), and results in execution of “Automation.dll” (303). FIG. 3 is shown for illustrative purposes only; DLLs may be leveraged from any appropriate software package, and any appropriate software development interface may be used to leverage the DLLs for use in functional testing software.

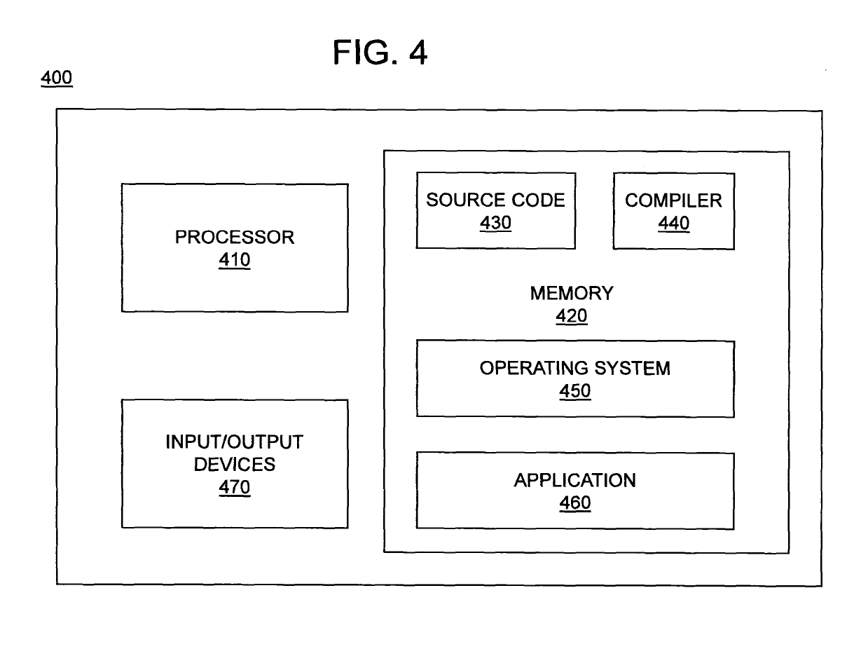

FIG. 4 illustrates an example of a computer 400 which may be utilized by exemplary embodiments of a method for functional testing using leveraged DLLs as embodied in software. Various operations discussed above may utilize the capabilities of the computer 400. One or more of the capabilities of the computer 400 may be incorporated in any element, module, application, and/or component discussed herein.

The computer 400 includes, but is not limited to, PCs, workstations, laptops, PDAs, palm devices, servers, storages, and the like. Generally, in terms of hardware architecture, the computer 400 may include one or more processors 410, memory 420, and one or more input and/or output (I/O) devices 470 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 410 is a hardware device for executing software that can be stored in the memory 420. The processor 410 can be virtually any custom made or commercially available processor, a central processing unit (CPU), a digital signal processor (DSP), or an auxiliary processor among several processors associated with the computer 400, and the processor 410 may be a semiconductor based microprocessor (in the form of a microchip) or a macroprocessor.

The memory 420 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 420 may incorporate electronic, magnetic, optical, and/or other types of storage media. Note that the memory 420 can have a distributed architecture, where various components are situated remote from one another, but can be accessed by the processor 410.

The software in the memory 420 may include one or more separate programs, each of which comprises an ordered listing of executable instructions for implementing logical functions. The software in the memory 420 includes a suitable operating system (O/S) 450, compiler 440, source code 430, and one or more applications 460 in accordance with exemplary embodiments. As illustrated, the application 460 comprises numerous functional components for implementing the features and operations of the exemplary embodiments. The application 460 of the computer 400 may represent various applications, computational units, logic, functional units, processes, operations, virtual entities, and/or modules in accordance with exemplary embodiments, but the application 460 is not meant to be a limitation.

The operating system 450 controls the execution of other computer programs, and provides scheduling, input-output control, file and data management, memory management, and communication control and related services. It is contemplated by the inventors that the application 460 for implementing exemplary embodiments may be applicable on all commercially available operating systems.

Application 460 may be a source program, executable program (object code), script, or any other entity comprising a set of instructions to be performed. When a source program, then the program is usually translated via a compiler (such as the compiler 440), assembler, interpreter, or the like, which may or may not be included within the memory 420, so as to operate properly in connection with the O/S 450. Furthermore, the application 460 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 470 may include input devices such as, for example but not limited to, a mouse, keyboard, scanner, microphone, camera, etc. Furthermore, the I/O devices 470 may also include output devices, for example but not limited to a printer, display, etc. Finally, the I/O devices 470 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 470 also include components for communicating over various networks, such as the Internet or intranet.

If the computer 400 is a PC, workstation, intelligent device or the like, the software in the memory 420 may further include a basic input output system (BIOS) (omitted for simplicity). The BIOS is a set of essential software routines that initialize and test hardware at startup, start the O/S 450, and support the transfer of data among the hardware devices. The BIOS is stored in some type of read-only-memory, such as ROM, PROM, EPROM, EEPROM or the like, so that the BIOS can be executed when the computer 400 is activated.

When the computer 400 is in operation, the processor 410 is configured to execute software stored within the memory 420, to communicate data to and from the memory 420, and to generally control operations of the computer 400 pursuant to the software. The application 460 and the O/S 450 are read, in whole or in part, by the processor 410, perhaps buffered within the processor 410, and then executed.

When the application 460 is implemented in software it should be noted that the application 460 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 460 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 460 is implemented in hardware, the application 460 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for functional testing of a power device with an associated software control system comprises:
referencing a dynamic linked library (DLL) file belonging to a software package via a method of a class;
instantiating an object of the class in functional testing software; and
including a call to the method of the object in the functional testing software, wherein the call to the method executes a function of the referenced DLL, such that the referenced DLL comprises an implementation of the class.

2. The method of claim 1, further comprising performing functional testing of the power device via the associated software control system using the functional testing software, wherein the DLL is executed during the functional testing via the call to the method of the instantiated object in the functional testing software.

3. The method of claim 1, wherein the software package comprises a plurality of DLLs, wherein the plurality of DLLs of the software package are referenced by a respective plurality of methods of the class.

4. The method of claim 1, wherein the functional testing software comprises automated functional testing software.

5. The method of claim 1, wherein the functional testing software is configured to perform functional testing of the associated software control system, and wherein the power device comprises one of a solar power converter and a wind power converter.

6. The method of claim 1, wherein the functional testing software comprises a computer program written an object oriented computer language.

7. The method of claim 1, wherein the reference to the DLL comprises a reference to a memory location of the DLL in an installation location of the software package in a computer memory, and wherein the call to the method executes the DLL via the reference to the memory location.

8. A computer program product comprising a computer readable storage medium containing computer code that, when executed by a computer, implements a method for functional testing of a power device with an associated software control system, wherein the method comprises:
referencing a dynamic linked library (DLL) file belonging to a software package as a method of a class;
instantiating an object of the class in functional testing software; and
including a call to the method of the object in the functional testing software, wherein the call to the method executes a function of the referenced DLL, such that the referenced DLL comprises an implementation of the class.

9. The computer program product according to claim 8, further comprising performing functional testing of the power device via the associated software control system using the functional testing software, wherein the DLL is executed during the functional testing via the call to the method of the instantiated object in the functional testing software.

10. The computer program product according to claim 8, wherein the software package comprises a plurality of DLLs, wherein the plurality of DLLs of the software package are referenced by a respective plurality of methods of the class.

11. The computer program product according to claim 8, wherein the functional testing software comprises automated functional testing software.

12. The computer program product according to claim 8, wherein the functional testing software is configured to perform functional testing of the associated software control system, and wherein the power device comprises one of a solar power converter and a wind power converter.

13. The computer program product according to claim 8, wherein the functional testing software comprises a computer program written an object oriented computer language.

14. The computer program product according to claim 8, wherein the reference to the DLL comprises a reference to a memory location of the DLL in an installation location of the software package in a computer memory, and wherein the call to the method executes the DLL via the reference to the memory location.

15. A system for functional testing of a power device with an associated software control system comprises:
a software package, the software package comprising a plurality of dynamic linked library (DLL) files; and
functional testing software, the functional testing software comprising an object comprising an instantiation of a class, the class comprising a method that references a DLL of the plurality of DLLs of the software package, wherein the functional testing software further comprising a call to the method of the object that references the DLL, wherein the call to the method executes a function of the referenced DLL during functional testing of the power device and associated software control system, such that the referenced DLL comprises an implementation of the class.

16. The system of claim 15, wherein the software package comprises a plurality of DLLs, wherein the plurality of DLLs of the software package are referenced by a respective plurality of methods of the class.

17. The system of claim 15, wherein the functional testing software comprises automated functional testing software.

18. The system of claim 15, wherein the functional testing software is configured to perform functional testing of the associated software control system, and wherein the power device comprises one of a solar power converter and a wind power converter.

19. The system of claim 15, wherein the reference to the DLL comprises a reference to a memory location of the DLL in an installation location of the software package in a computer memory, and wherein the call to the method executes the DLL via the reference to the memory location.
